(19) United States
(12) Patent Application Publication
(10) Pub. No.: US 2019/0308705 A1
(43) Pub. Date: Oct. 10, 2019

(54) LAUNCH PLATFORM FOR AN UNMANNED VEHICLE

(71) Applicant: Kongsberg Ferrotech AS, Kongsberg (NO)

(72) Inventors: Luis Fidel DE LA TORRE UGARTE DEL CASTILLO, Kongsberg (NO); Bert PASOP, Raudsand (NO)

(21) Appl. No.: 16/318,529

(22) PCT Filed: Jul. 18, 2017
(86) PCT No.: PCT/NO2017/050196

§ 371 Date: Jan. 17, 2019

(30) Foreign Application Priority Data
Jul. 19, 2016 (GB) 1612526.2

(51) Int. Cl. B63C 11/52; B63G 8/00; B63G 8/42; F16L 55/18; B25J 11/00; B25J 5/00

(52) U.S. Cl. CPC B63C 11/52; B63G 8/001; B63G 8/42; B63G 2008/005; B25J 11/0085; B25J 5/00; B63G 2008/004; F16L 55/18

(57) ABSTRACT

A carrier vehicle carries an unmanned subsea vehicle along an elongate body from a topside location to a subsea location. The carrier vehicle comprises a support structure configured to carry the unmanned subsea vehicle, and a translation mechanism comprising gripper arms connected to the support structure for causing the carrier vehicle to translate along the elongate body using a hand¬over-hand action. The carrier vehicle can carry the subsea vehicle through a region of turbulence, such as a splash zone. This removes the need for special launch equipment to be installed on the platform to use the subsea vehicle.

The present invention relates to a mobile launch platform for launching remote and/or autonomous vehicles.

Inspection, maintenance and repair of subsea pipelines and risers is often carried out using unmanned underwater vehicles (UUVs), such as a remotely operated underwater vehicle (ROUV) or an autonomous underwater vehicle (AUV).

An ROUV, for example, is an underwater mobile device, operated by a crew aboard a vessel. Most ROUVs are equipped with at least a video camera and lights, but additional equipment is commonly added to expand the vehicle's capabilities, such as a manipulator or cutting arm, and various measurement instruments.

An AUV is a robot which travels underwater without requiring input from an operator. An AUV may also carry equipment such as a manipulator or cutting arm, and various measurement instruments

One limitation of UUVs is that they cannot operate in the splash zone of a platform, i.e. the air-water boundary. Thus, a UUV will either be launched and returned from/to a separate vessel, which will typically be stationed in port and requested as required, or it will be launched by a dedicated launch and recovery system (LARS) installed on the platform. However, using a separate vessel introduces additional delays when such maintenance is required, and a LARS is a large and expensive structure and is not common on many smaller platforms.

The present invention provides a carrier vehicle for carrying a secondary vehicle along an elongate body, the carrier vehicle comprising a support structure configured to carry the secondary vehicle, and a translation mechanism connected to the support structure for causing the carrier vehicle to translate along the elongate body, wherein the secondary vehicle is capable of movement independently of the carrier vehicle.

The present arrangement of carrier vehicle and secondary vehicle provides a mobile, remote launching platform for the secondary vehicle. This means that the secondary vehicle does not need to be piloted for long distances to a specific location, but can instead be carried by the carrier vehicle, which simply moves along the elongate body. Furthermore, the carrier vehicle may be less prone to certain types of turbulence arising in specific areas, such as a splash zone, thus allowing the secondary vehicle to be carried safely through these areas. This reduces the need to special launch equipment to be installed on the platform to use the secondary vehicle. Furthermore, the carrier vehicle can provide a remote station for recharging or re-fuelling the secondary vehicle, or for depositing material such as collected samples or data.

In various embodiments, the secondary vehicle may be capable of movement independently of the carrier vehicle so as to perform an operation on a structure separate from the elongate body. The structure is preferably in the vicinity of the elongate body. In various embodiments, the secondary vehicle may be capable of performing an operation on a structure anywhere within the operational range of the secondary vehicle. The operational range of the secondary vehicle will depend on the nature of the secondary vehicle, for example how it is powered, e.g. the size of its battery, and how it is controlled, e.g. autonomously, or remotely via wireless communication or via a tether. In one example, it may be capable of performing operations on a structure within 100 m of the carrier vehicle, but in other embodiments the distance may be greater, such as within 500 m or within 1 km or even further.

The carrier vehicle may be a crawler-type carrier vehicle. The term “crawler” refers to a class of vehicles which at least partially surround a pipeline and use rollers, tracks, grippers or the like to “crawl” along the pipeline. Such devices are easily controlled and allow precise positioning with respect to the pipeline.

The elongate body is preferably a tubular body, and preferably a subsea pipeline such as a riser. The secondary vehicle is then preferably a subsea vehicle. Other elongate bodies may include, for example, platform legs, topside pipes, scaffolding, and the like.

The secondary vehicle is preferably an unmanned vehicle, and more preferably an unmanned underwater vehicle (UUV), such as a remotely operated underwater vehicle (ROUV). It will be understood, however, that other unmanned vehicles may also be used as appropriate, such as unmanned aerial vehicle (UAV) or a remote controlled (land) vehicle (RCV). That is to say, the carrier vehicle may be used to carry a secondary vehicle for performing surface operations.

The secondary vehicle is preferably configured to perform one or more operations on the elongate structure or on a structure in the vicinity of the elongate structure, such as a wellhead or a platform. Such operations may include one or more of inspection operations, maintenance operations (such as cleaning and/or repair operations), upgrading operations, decommissioning operations, and the like.

The carrier vehicle preferably comprises a mount configured to carry the secondary vehicle, such as a docking station or the like. The mount preferably comprises a releasable connection capable of carrying the secondary vehicle.

The carrier vehicle may comprise a tether connecting the secondary vehicle to the carrier vehicle or the carrier vehicle may be configured to communicate wirelessly with the secondary vehicle. Alternatively, the secondary vehicle may be autonomous, or have a combination of autonomous and remotely controllable functions.

The secondary vehicle may be equipped with one or more inspection tools, such as a camera, an ultrasonic sensor, and the like. The secondary vehicle may be equipped with manipulators. The secondary vehicle may be equipped with other tools, such as a cleaning tool, a torque tool, and the like.

The secondary vehicle may comprise a battery, and may be configured to recharge the battery when connected to the carrier vehicle. This is particularly advantageous where the secondary vehicle is not connected, such as via a tether, umbilical, or the like, to the carrier vehicle. The secondary vehicle may be configured to download data to the carrier vehicle when connected thereto.

In one embodiment, the carrier vehicle may comprise an elongate support structure for carrying the secondary vehicle. The elongate support structure may provide a backbone for the carrier vehicle.

The carrier vehicle is preferably configured to hold the support structure a distance away from the elongate body. The translation mechanism is preferably connected to the support structure for causing the carrier vehicle to translate along the elongate body. Whilst the following embodiments relate to a carrier vehicle including an elongate support structure, it should be appreciated that in alternative arrangements the support structure may not be elongate.

The carrier vehicle described above has an arrangement whereby the secondary vehicle is carried using an elongate support structure, which is in turn held away from the elongate body. Thus, the elongate support structure is relatively narrow and so can easily pass even large protuberances along the elongate body.

The elongate body may have at least one protuberance along its length. Exemplary protuberances may include structures on the elongate body, such as one or more of a clamp, a valve and a mooring line. The protuberances may also include accumulated matter on the surface of the body, such as rust, organic matter or the like.

The carrier vehicle may be configured to pass a protuberance on the elongate body, preferably whilst remaining engaged with the elongate body. The term obstacle is also sometimes used to refer to such a protuberance.

Preferably the carrier vehicle is configured such that every part of the carrier vehicle is capable of passing a protuberance having a total width of at least twice the width of the elongate body, such as a clamp or valve.

Preferably the carrier vehicle is also or alternatively configured such that every part of the carrier vehicle is capable of passing a protuberance extending indefinitely away from the elongate body, such as a mooring line. In one embodiment, every part of the carrier vehicle is capable of achieving a clearance angle of at least 90° with respect to the axis of the elongate body to pass the protuberance, i.e. there is an angular sector into which the part does not intrude. Preferably every part of the carrier vehicle is capable of achieving a clearance angle of at least 135°, and most preferably at least 180°. In some embodiments, even greater angle may be achieved, for example up to 270°. Such a configuration allows the carrier vehicle to translate along complex structures, for example where the elongate body is supported by two or more members, such as in an apex frame or the like.

It will be appreciated that the elongate support structure preferably does not completely surround the elongate body. In preferred embodiments, the elongate support structure preferably does not surround more than 180° of the elongate body, preferably less than 90° and preferably less than 45°. That is to say, from the axis of the elongate body, the elongate support structure fits within an angle of view of 180°, preferably within 90° and more preferably within 45°.

The carrier vehicle is preferably configured to hold the elongate support structure such that it is substantially aligned with the elongate body. Where both the elongate body and elongate support structure are straight, the carrier vehicle is preferably configured to hold the elongate support structure such that it is substantially parallel with the elongate body, e.g. within 10°.

The elongate support structure preferably has a constant length. That is to say, the support structure does not extend and contract its overall length. Instead, one or more parts of the carrier vehicle may move with respect to the support structure, e.g. by sliding up and down its length. In some embodiments, the elongate support body may be a rigid member. In other embodiments, the elongate support structure may comprise an articulated member, having two or more hinged sections. In that case, each section preferably has a constant length.

The carrier vehicle may comprise one or more guide assemblies for aligning the carrier vehicle, and preferably the support structure in particular, with respect to the elongate body. The guide assemblies preferably restrict at least one degree of movement with respect to the elongate body, and preferably restrict all degrees of movement except for axial movement along the elongate body and/or rotation about the axis of the elongate body.

The guide assemblies are preferably connected to the support structure. The guide assemblies may be configured to hold the weight of the support structure. However, in preferred embodiments the guide assemblies provide only an aligning function and do not support the majority of the weight of the carrier vehicle.

Each guide assembly is preferably configured to pass a protuberance on the elongate body. For example, each guide assembly may be configured to be movable away from the elongate body, either passively or in a controlled manner.

Each guide assembly preferably comprises at least two engagement members for engaging the elongate body from different directions. For example, the guide assembly may comprise a yoke supporting the engagement members on opposing sides of the elongate body. The engagement members preferably comprise rollers, although other forms of engagement member could be used. Preferably the engagement members are connected to the support structure so as to allow them to disengage from the elongate body. For example, the engagement members may be mounted on arms rotatable about an axis offset from the axis of the elongate body. The axis may be substantially parallel to the axis of the elongate body or it may be substantially parallel to a direction perpendicular to the axis of the elongate body.

The translation mechanism preferably comprises at least two translation members, such as grippers, belts, wheels, tracks or the like. Preferably each of the translation members is configured to be disengageable from the elongate body to pass a protuberance. Preferably the translation mechanism can support the weight of both the carrier vehicle and the secondary vehicle under designed operating conditions when at least one of the translation members is disengaged from the elongate body. Preferably the translation mechanism can also support the weight of both the carrier vehicle and the secondary vehicle under atmospheric conditions, e.g. when out of water.

Preferably the translation mechanism is configured such that the carrier vehicle can translate with at least one translation member engaged with the elongate body at all times. Preferably the translation mechanism is configured such that, in the event of loss of power, at least one translation member remains engaged with the elongate body.

Where the carrier vehicle comprises a support structure, the translation mechanism may be configured to hold the support structure at either fixed distance away from the elongate body or at a controllable distance away from the elongate body. For example, each translation member may be supported by an arm connected to the support structure.

The carrier vehicle may use any suitable translation mechanisms. For example, the translation members may comprise wheels or rollers driven by a motor. Alternatively, the carrier vehicle may use thrusters, propellers or the like. Preferably, however, each translation member comprises a gripper configured to grip the elongate body. Grippers have been found to provide the most reliable and precise means of translation along an elongate body. Of particular importance is that a gripper does not normally allow any axial movement when gripped, ensuring that the carrier vehicle does not move in the event of loss of power (provided the gripper remains engaged). Thus, for example, where the carrier vehicle is waiting for the secondary vehicle to complete an operation, the translation mechanism may be powered down to reduce power consumption of the carrier vehicle.

Preferably at least one of the grippers is movable in the axial direction of the elongate body. Thus, the carrier vehicle can translate along the elongate body by gripping the elongate body, moving the movable gripper, reversing which grippers grip the elongate body, and reversing the movement of the movable. As discussed above, the carrier vehicle is preferably configured such that there is always at least one gripper engaged with the elongate body at any time. The grippers are preferably configured to not release the elongate body in the event of loss of power.

In a preferred embodiment, the at least one gripper is movable so as to move past at least one other gripper. This increases the range of movement available for the grippers within a given length of space, allowing the carrier vehicle to move further for each grip-move cycle.

The translation mechanism preferably comprises two arms with one of the grippers at the end of each arm. Each of the arms can preferably be swung aside from the elongate body to allow the carrier vehicle to pass a protuberance. Preferably each arm can be swung to an angle of at least 45° with respect to the axis of the support structure.

In one embodiment, each gripper comprises first and second clamps arranged to oppose each other, wherein the clamps define a path for the elongate body to be received therebetween. The gripper preferably further comprises an actuation mechanism configured to drive the first and second clamps to move towards the path. In one arrangement, two frame members connect to the first and second clamps, respectively, the frame members being pivotally connected to one another about an axis perpendicular to the path. The actuation mechanism may then be configured to drive a relative rotation between the frame members causing the first and second clamps to move towards the path.

The gripper may further comprise third and fourth clamps arranged to oppose each other and being axially offset along the path from the third and fourth clamps. Of the two frame members, one may connect the first and fourth clamps and the other may connect the second and third clamps. When the actuation mechanism drives relative rotation between the frame members the first and second clamps and the third and fourth clamps are each caused to move towards the path. This gripper configuration provides a stable connection where the elongate body is gripped in a manner that provides resistance of rotation of the gripper, and hence the carrier vehicle, about the axis perpendicular to the elongate body.

The actuation mechanism may be configured to push the second clamp away from the fourth clamp to drive the rotation of the frame members.

The actuation mechanism preferably comprises two linkage members pivotally connected to one another and pivotally connected at their free ends to one of the frame members, respectively. The actuation mechanism preferably drives the relative rotation by driving the pivotally connected ends of the linkage members towards or away from the axis of rotation of the frames. The linkages are preferably driven by a linear actuator.

The linkage members are preferably sized so as to be aligned in a straight line when the gripper is in its engaged position. The linkage members are preferably shaped to permit movement beyond the straight line position into an overextended position, but to prevent further movement beyond the overextended position. In this position, the gripper is slightly released from its maximum grip, but a force pushing the gripper in the release direction pushes the linkages further in the overextended direction, which is prevented by the shape of the linkages. This configuration requires no power to remain engaged, thus providing a failsafe gripper. In the overextended position, the linkage members are preferably less than 20°, and more preferably less than 10°, away from the straight line direction.

In one embodiment, the carrier vehicle may be adaptable for use with multiple elongate bodies of different cross-sectional shape. For example, the clamps of the gripper or the grippers themselves may be configured to be interchangeable.

The grippers may each be part of a gripper system. The system may comprise a mount, an arm connected to the mount via a hinge and the gripper. In one arrangement, each gripper system may comprise a linear actuator oriented in a direction parallel to the hinge axis, and the linear actuator is connected to the linkage via an arm. The gripper system is preferably arranged such that movement of the linear actuator causes the linkage to first release the clamps and then to rotate the arm about the hinge. This occurs because the axis of the actuator is offset from the axis of the hinge. Thus, when the linkage reaches the limit of its travel, the arm is swung aside by the continued movement of the actuator.

The carrier vehicle may comprise two or more such gripper systems, preferably connected to the support structures via their mounts, where at least one of the gripper systems is movable with respect to the support structure

The carrier vehicle, and preferably the translation mechanism in particular, is preferably configured to drive controlled rotation of the carrier vehicle around the axis of the elongate body.

In one arrangement, each clamp of the gripper preferably includes a housing and a friction pad for engaging the elongate body. The friction pad is preferably movable with respect to the housing to cause the housing to rotate about an axis of the elongate body. Thus, where the housing is connected to the support structure, e.g. via the frame members of the gripper, the relative rotation of the housing and the friction pad will cause the carrier vehicle to rotate about the axis of the elongate body.

In one embodiment, the secondary vehicle is carried by a launch module of the carrier vehicle. The carrier vehicle may be arranged to carry one or more further modules for a variety of purposes. Preferably, the one or more modules are configured to perform one or more operations on the riser or on a structure in the vicinity of the riser. Such operations may include one or more of inspection operations, maintenance operations (such as cleaning and/or repair operations), upgrading operations, decommissioning operations, and the like. For example, the one or more modules may include at least one of a repair module, a cleaning module, an inspection module and a manipulator module.

In such an arrangement, the carrier vehicle may be capable of performing one or more operations on the elongate body itself, whilst the secondary vehicle can perform one or more operations on structure in the vicinity of the elongate body.

The launch module and/or the one or more further modules may be permanently connected to the support structure. Preferably, however, at least one of the one or more further modules is interchangeable, i.e. such that it can be removed and replaced by another, different module. Thus, the vehicle may comprise one or more module connection points for alternate connection of at least two different modules. This modular configuration allows for a single vehicle to be used for multiple purposes. For example, the carrier vehicle may be used to perform an inspection process followed by a repair process, i.e. by first using an inspection module, removing the inspection module, and replacing the inspection module with a repair module.

In one embodiment, the carrier vehicle may comprise a repair module. The repair module is preferably a re-usable repair module. The repair module may comprise a housing shaped to surround the elongate body, establishing a sealed chamber between the housing and the elongate body. The repair module is preferably capable of draining water from the sealed chamber and/or performing a repair on the elongate body using a self-contained repair apparatus. The repair module may be configured to fill the sealed chamber with a fluid during the repair. The fluid may be air or another gas, pure water, a cleaning fluid or other agent. The vehicle or repair module may include a local source of fluid or may comprise a connection to a remote source, such as via an umbilical.

The housing of the repair module may comprise two housing segments that, when engaged with one another around an elongate body, form the sealed chamber. The housing segments are preferably separated by a rotational movement about a pivot axis.

The repair module is preferably carried by the support structure via a frame, which provides pivots about which the housing segments rotate to engage or disengage the elongate body. The frame is preferably shaped so that the housing segments, when closed, will close around the elongate body when the vehicle engages the elongate body. The repair module is preferably capable of passing a protuberance on the elongate body when the housing segments are in their open position.

At least one of the housing segments preferably includes a seal along its free edge for sealing against the other housing segment. The housing preferably further comprises a sealing arrangement for sealing against the elongate body. The sealing arrangement is preferably provided with a part on each housing segment.

The sealing arrangement may comprise a seal stack shaped to surround the elongate body, the seal stack comprising at least three seal members interleaved with spacers so as to define at least two chambers between adjacent seal members, wherein one of the chambers is connected to a pressurised fluid conduit to provide a fluid barrier, and wherein another of the chambers is connected to a drain conduit.

This seal configuration provides a good configuration for sealing against an elongate body that does not have an even surface, as is likely to be the case where repair is required. Should water leak past one seal, it can be drained via the drain conduit to reduce its pressure. Furthermore, a fluid barrier is provided that opposes ingress of water beyond the fluid barrier.

Preferably a frame is provided around the seal stack and a compression assembly is provided to compress the seal stack against the frame. This configuration applies pressure to the seal stack, causing it to expand radially and engage the elongate body.

The compression assembly may comprise a lever arm connected to the frame and arranged to press on the seal stack. Optionally a compression ring may be provided between the seal stack and the lever arm. A linear actuator may be connected to the other end of the lever arm to cause it to press on the seal stack. This allows for engagement of the seal in a precise and controlled manner.

In an alternate arrangement, the compression assembly may comprise a pair of threaded elements, wherein one threaded element is axially fixed to the frame such that relative rotation of the elements applies compression to the seal stack.

Preferably the fluid barrier chamber is inward with respect to the drain chamber. That is to say, the fluid barrier chamber is closer to the sealed chamber of the repair module. In one embodiment, the fluid barrier chamber is formed adjacent the innermost seal member of the seal stack. In alternative arrangements, however, fluid barrier chamber may be outwards with respect to the drain chamber, i.e. towards the exterior.

The seal assembly is preferably configured to supply fluid to the fluid barrier at a pressure higher than the pressure outside the seal assembly. Thus, the fluid barrier opposes the ingress of water into the sealed chamber. Preferably the fluid forming the fluid barrier is the same as a fluid filling the sealed chamber.

Preferably the seal members are provided in a replaceable cartridge. Optionally, the spacers may also be provided in the replaceable cartridge. Thus, the sealing member can be replaced with different seals, for example to seal against elongate bodies of different shapes or materials, or to improve a seal against a particularly uneven body.

In one embodiment, the one or more modules may comprise a manipulator module. The manipulator module preferably comprises a manipulator, such as a gripper or the like. The manipulator may be provided on an articulated arm, for example, such that the vehicle can perform various operations on or around the elongate body.

In one embodiment, the one or more further modules may comprise a cleaning module. The cleaning module preferably comprises a cleaning tool for cleaning the elongate body or an object close to the elongate body.

In one embodiment, the cleaning tool comprises one or more brushes, or one or more flexible or elastomeric cleaning elements. Preferably the cleaning elements are arranged as outwardly elements rotatable by a rotor. The cleaning elements are preferably configured so as to repeatedly impact against a surface of the elongate body.

Optionally, either in addition or instead of the cleaning elements, the cleaning tool may comprise one or more fluid nozzles. The cleaning module may be configured to supply fluid from a fluid container, from topside through a tube, or from the surrounding environment, e.g. the fluid may be water. The cleaning module thus preferably comprises a pump for supplying pressurised fluid to the nozzles.

In one embodiment, a single module may be configured to operate as both a manipulator module and as a cleaning module. For example, the manipulator may be configured to carry a cleaning tool.

Viewed from another aspect, the present invention may also be seen to provide a method of performing an operation on a remote structure in the vicinity of an elongate body, the method comprising: carrying a secondary vehicle to a launch location along the elongate body using a carrier vehicle that translates along the elongate body; releasing the secondary vehicle from the carrier vehicle, such that the secondary vehicle is capable of movement independently of the carrier vehicle; and performing the operation on the remote structure using the secondary vehicle. The method is preferably performed using a vehicle including a launch module as described above or using a carrier vehicle as described above.

The method may further comprise, after performing the operation, mounting the secondary vehicle to the carrier vehicle; and preferably then carrying the secondary vehicle to another location along the elongate body using the carrier vehicle. For a subsea vehicle, the launch location may be subsea and the further location may be topside, for example.

In various embodiments, the elongate body is preferably a subsea tubular structure, such as a riser, and the secondary vehicle is preferably a remotely operated underwater vehicle.

The method preferably comprises carrying the secondary vehicle from a location topside to a subsea launch location, e.g. through the splash zone.

Certain preferred embodiments of the invention will now be described in greater detail by way of example only and with reference to the accompanying drawings, in which:

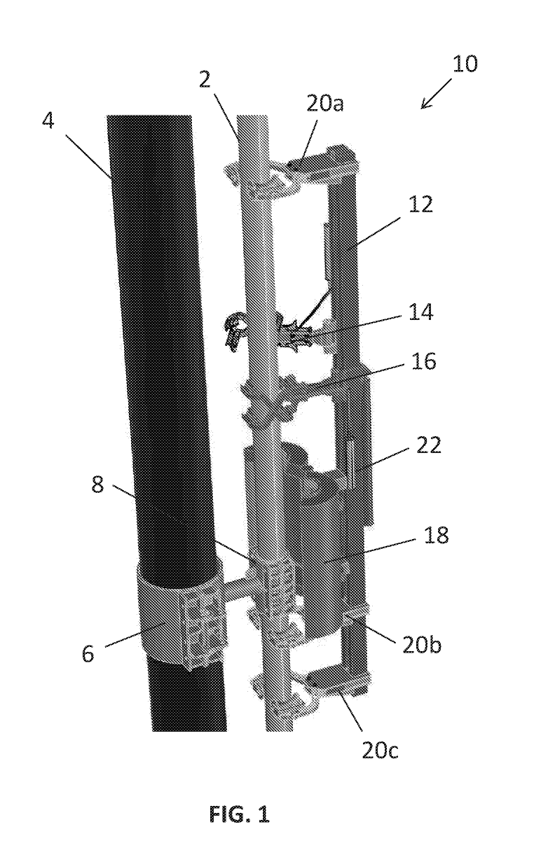

FIG. 1 shows a vehicle capable of translation along a pipeline;

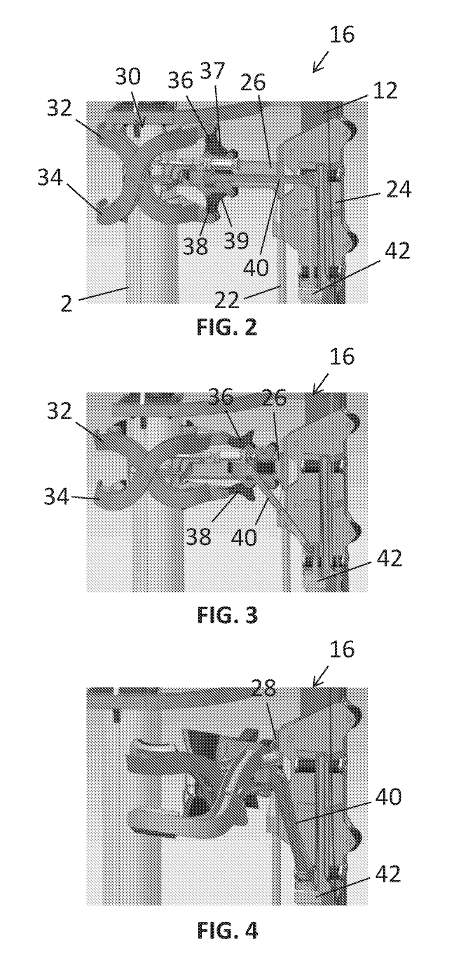

FIG. 2 shows a gripper of the vehicle engaged with the pipeline;

FIG. 3 shows the gripper of the vehicle releasing the pipeline;

FIG. 4 shows the gripper of the vehicle disengaged from the pipeline;

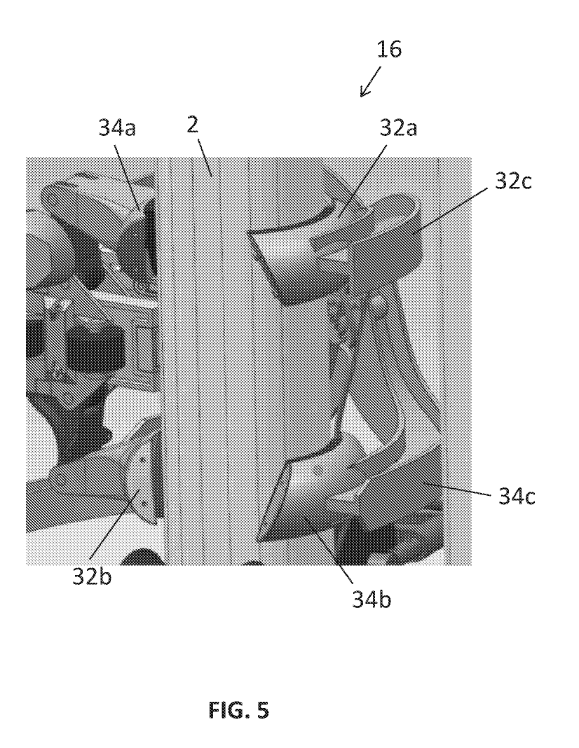

FIG. 5 shows details of the reverse side of the gripper shown in FIGS. 2 to 4;

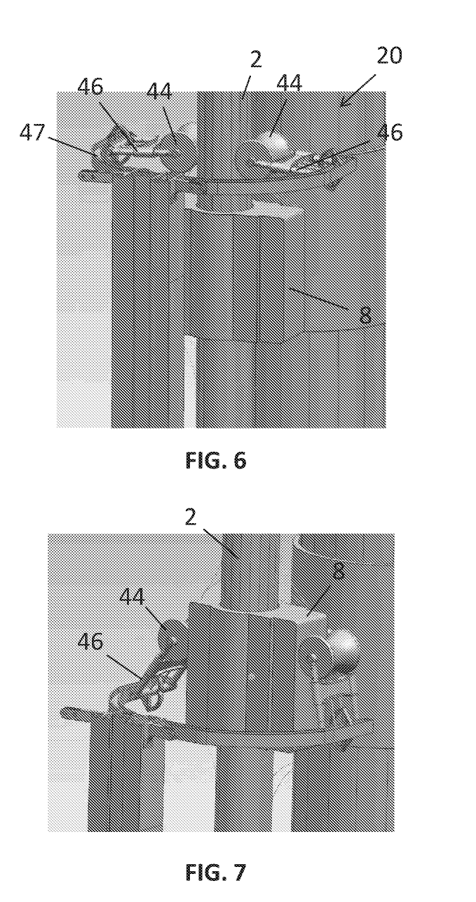

FIG. 6 shows an alternative rolling guide member of the vehicle engaged with the pipeline;

FIG. 7 shows the rolling guide member of FIG. 6 passing a protuberance on the pipeline;

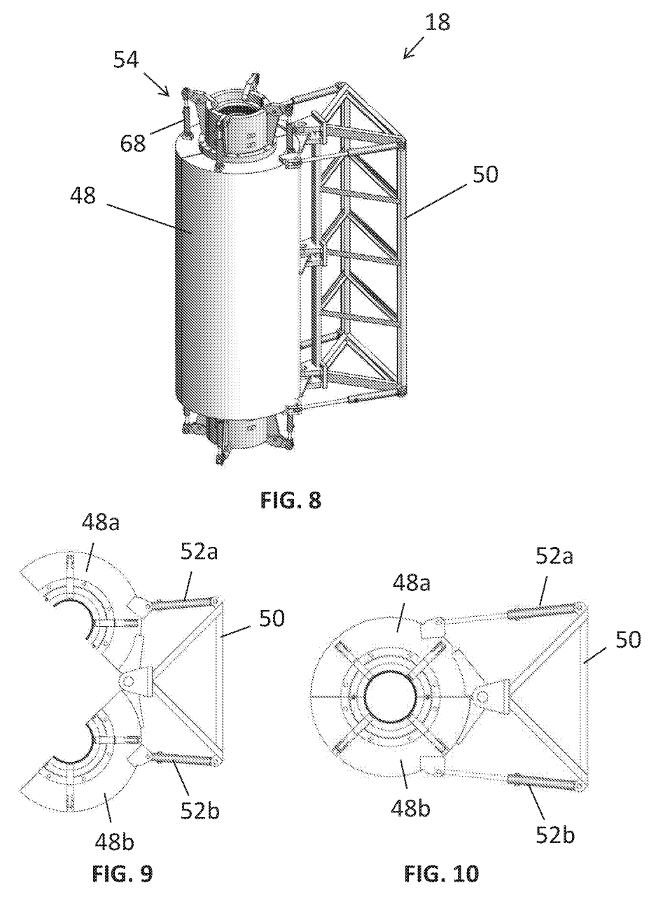

FIG. 8 shows details of a repair module to be carried by the vehicle;

FIG. 9 shows the repair module viewed in an axial direction in its open position;

FIG. 10 shows the repair module viewed in an axial direction in its closed position;

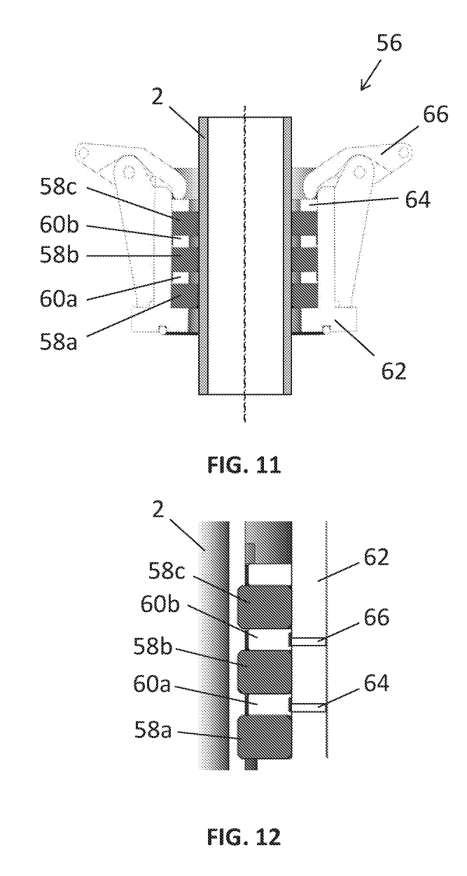

FIG. 11 shows a cross-section through a pipeline seal of the repair module;

FIG. 12 shows another cross-section through the pipeline seal showing access conduits;

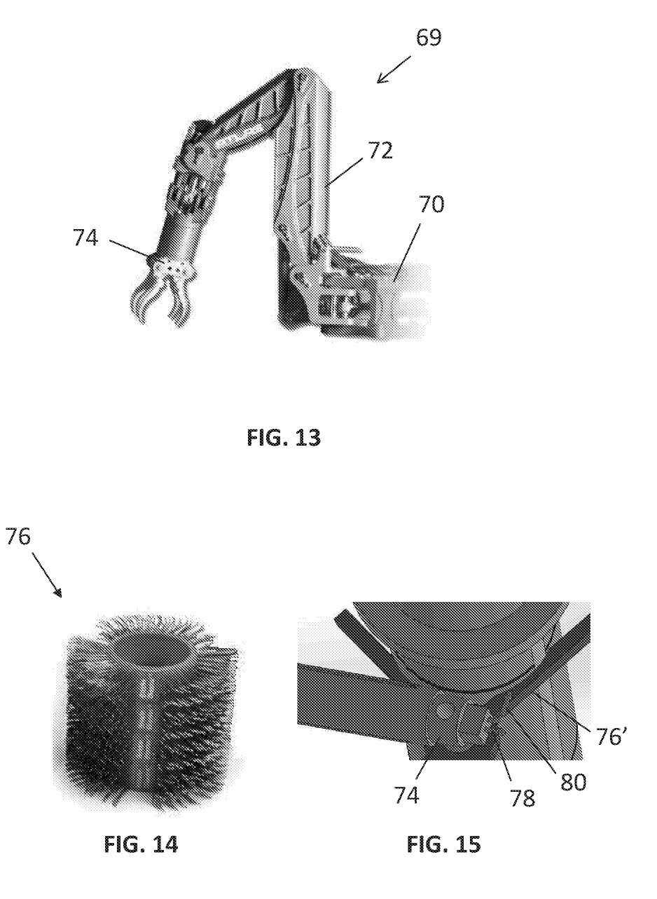

FIG. 13 shows a robotic arm to be carried by the vehicle;

FIG. 14 shows a cleaning tool to be carried by the robotic arm;

FIG. 15 shows an alternative cleaning tool carried by the robotic arm; and

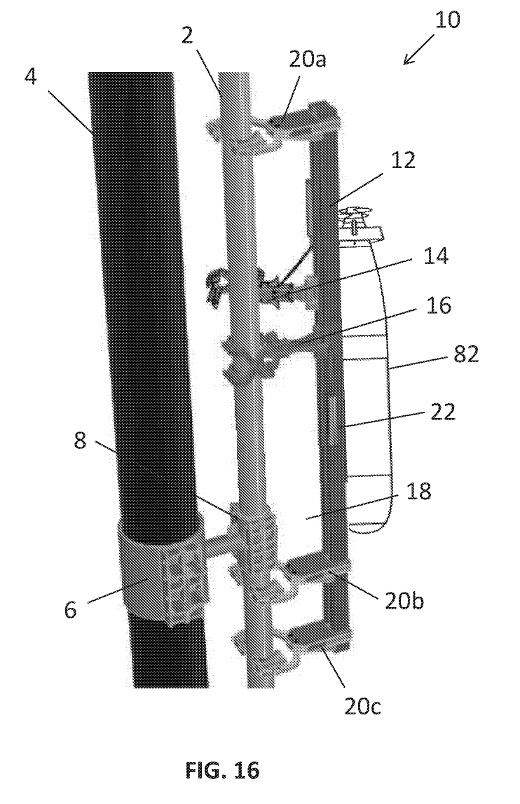

FIG. 16 shows the vehicle carrying an unmanned subsea vehicle.

FIG. 1 illustrates a vehicle 10 for carrying one or more modular components to be used during inspection, repair or maintenance of a subsea pipeline, such as a riser 2. As used herein, “inspection” refers to operations which assess the condition of the riser, and “maintenance” refers to operations required for maintaining the condition of the riser, such as cleaning the riser, and “repair” refers to operations for restoring the condition of the riser, such as repairing damage to the riser, and replacing damaged or used components associated with the riser. In FIG. 1, the riser 2 is mounted to a leg 4 of a platform by a plurality of riser offset clamps 6.

The vehicle 10 comprises a primary support structure 12, which acts as a backbone of the vehicle 10. The support structure 12 carries a translation mechanism 14, 16 for causing the vehicle 10 to move along the pipeline 2, as well as one or more modular components, such as the repair module 18 illustrated in FIG. 1. The support structure 12 optionally further carries one or more guide members 20 for guiding movement of the vehicle 10 along the pipeline 2.

The translation mechanism 14, 16, together with the guides 20, is designed to hold the support structure 12 away from riser 2 such that it can move past protuberances 8 on the body of the riser 2, such as the portion of the clamp 6 engaging the riser.

The translation mechanism 14, 16 comprises two gripper arms 14, 16. Each of the gripper arms 14, 16 has a gripper portion 30 shaped to grip the riser 2 and an arm portion 26 for holding the support structure 12 away from the riser 2. When engaged, each of the gripper arms 14, 16 is independently capable of carrying the full weight of the vehicle 10, including any modular components, under the intended operating conditions, e.g. subsea (or in a splash zone or in the air above the sea surface, as the case may be). In preferred embodiments, each of the gripper arms 14, 16 is also capable of supporting the full weight of the vehicle 10 out of the water and may be sufficiently strong to carry additional loading applied to the vehicle 10.

Each of the gripper arms 14, 16 is mounted on the support structure 12 in a manner that allows the respective gripper portions 30 to be moved away from the riser 2. This permits the gripper arms 14, 16 to move past any protuberances 8 on the body of the riser 2. In the illustrated embodiment, the arm portions 26 of the gripper arms 14, 16 are hingedly mounted to the support structure 12 such that they can rotate about an axis parallel to the riser 2 so as to move away from the riser 2.

The first gripper arm 14 is mounted to the support structure 12 such that it does not move in the axial direction of the riser 2. The second gripper arm 16 is mounted to the support structure 12 so as to be translatable with respect to the support structure 12 in the axial direction of the riser 2. A linear actuator 22 is connected at one end to the second gripper arm 16 and at the other end to the support structure 12, so as to effect the axial translation of the second gripper arm 16.

In order to cause the vehicle 10 to translate along the riser 2 in the upwards direction in FIG. 1, the following sequence of actions occur, starting from the position shown in FIG. 1. It will be appreciated that the reverse sequence will move the vehicle 10 in a downwards direction in FIG. 1.
a. The first gripper arm 14 engages and grips the riser 2.
b. The second gripper arm 16 releases the riser 2 and is swung aside, such that the first gripper arm 14 is carrying the weight of the vehicle 10.
c. The actuator 22 is extended to cause the second gripper arm 16 to move past the first gripper arm 14 in the axial direction of the riser.
d. The second gripper arm 16 engages and grips the riser 2.
e. The first gripper arm 14 releases the riser 2 and is swung aside, such that the second gripper arm 16 is carrying the weight of the vehicle 10.
f. The actuator 22 is retracted causing the support structure 12 to be lifted up, moving the first gripper arm 14 past the second gripper arm 16 and returning the vehicle 10 to the position illustrated in FIG. 1.

As will be appreciated, one of the gripper arms 14, 16 is engaged with and gripping the riser 2 at every stage of the movement. Each of the gripper arms 14, 16 is configured so that they will not release the riser 2 in the event of power failure. Thus, should the vehicle 10 suffer a power failure, it will not detach from the riser 2 or move along the riser 2.

This hand-over-hand movement action permits the vehicle 10 to easily traverse protuberances 8 on the riser 2 without becoming disengaged from the riser 2. The range of the actuator 22 is sufficient to allow the second gripper arm 16 to move past both the protuberance 8 and the first gripper arm 14.

Further details of the second gripper arm 16 are illustrated in FIGS. 2 to 5. The first gripper arm 14 operates in substantially the same manner as the second gripper arm 16, except that instead of a sliding mount 24 it has a static mount.

The second gripper arm 16 comprises a sliding mount 24 configured to slide axially along the support structure 12. In the illustrated embodiment, the sliding mount 24 comprises a frame with wheels engaging corresponding tracks of the support structure 12, although alternative connections types may be used.

An arm portion 26 of the gripper arm 16 is connected at one end to the sliding mount 24 by a hinge 28. At the other end of the arm portion 26 is provided a gripper portion 30.

The gripper portion 30 comprises first and second clamp members 32, 34. Each of the clamp members comprises, with reference to FIG. 5, an upper clamp 32a, 34a and a lower clamp 32b, 34b. The upper and lower clamps 32a, 34a, 32b, 34b of each clamp member 32, 34 are held on opposite sides of the riser 2 by a bracket 32c, 34c. The upper clamp 32a of the first clamp member 32 opposes the upper clamp 34a of the second clamp member 34. Similarly, the lower clamp 32b of the first clamp member 32 opposes the lower clamp 34b of the second clamp member 34.

The brackets 32c, 34c are approximately S-shaped when viewed in a direction perpendicular to the axial direction of the riser 2, and approximately U-shaped when viewed in the axial direction of the riser 2. The brackets 32c, 34c are connected to one another so as to pivot about an axis perpendicular to the riser 2. The riser 2 is clamped between the upper clamps 32a, 34a and between the lower clamps 32b, 34b when the lower end 32b of the first clamp member 32 and the upper end 34a of the second clamp member 34 are pushed away from one another.

The lower end 32b of the first clamp member 32 and the upper end 34a of the second clamp member 34 are hingedly connected to respective linkage members 36, 38 for causing the clamping portion 30 to clamp the riser 30, as illustrated in FIG. 2. At their other ends, the linkage members 36, 38 are slidably connected to move along the arm portion 26 towards and away from the support structure 12. In this arrangement, the linkage members 36, 38 are connected to a wheeled frame that moves along the arm portion 26, although alternative solutions may also be used.

The linkage members 36, 38 are driven by a clamp driving member 40. At one end, the clamp-driving member 40 is connected to the linkage members 36, 38 so as to slide long the arm portion 26. The other end of the clamp-driving member 40 is connected to the mount 24 so as to be movable in the axial direction of the riser 2. This end of the clamp-driving member 40 is in turn connected to a clamp actuator 42, for driving the clamp portion 30.

When the clamp actuator 42 is in its extended position, the linkage elements 36, 38 hold the clamp members 32, 34 against the riser 2. In this position, the linkage elements 36, 38 are held in a position where they are slightly beyond perpendicular to the axial direction of the arm portion 26. A stop 37, 39 is formed on outer side of each linkage element 36, 38 to prevent further rotation of the linkage elements 32, 34 beyond this position, and hence preventing further translation of the wheeled frame supporting the linkage elements 36, 38. Thus, when the linkage elements 36, 38 are pushed beyond their perpendicular position, they are held in position. The linkage elements 36, 38 are effectively locked in this position because of the flexibility in the mechanism, provided for example by the flexibility of the linkages 36, 38, the frames 32c, 34c and the clamps 32a, 32b, 34a, 34b. Hence a force is required in order to pull the mechanism out of lock (reversing the movement) past the vertical position. Furthermore, any opening force applied to the gripper portion 30 drives the linkages further into lock and is counteracted by the stops 37, 39. As a result, little to no resistance is required from the clamp actuator 42 to hold the gripper portion 30 closed, and thus it remains gripped should power to the clamp actuator 42 fail. The end position is controlled by the stops 37, 39 on the linkage elements or by limiting the stroke of the actuation mechanism.

To release the gripper portion 30, a pulling force must be applied to the linkage elements 36, 38 to move them out of the locked position and past the perpendicular (neutral/equilibrium) point. This pulling force is applied by the actuator 42, which is retracted first to an intermediate position, shown in FIG. 3. This movement causes the linkage members 36, 38 to move along the arm portion 26 towards the support structure 12. In doing so, the lower end of the first clamp member 32 and the upper end of the second clamp member 34 are brought towards each other, causing them to release the clamps 32a, 32n 34a, 34b from the riser 2.

The extension/retraction direction of the clamp actuator 42 is offset from the axis of the hinge 28 in a direction perpendicular to the direction of the arm 26 when engaged with the riser. Thus, when the wheeled frame reaches the limit of its movement along the arm portion 26, the continued retraction of the actuator 42 causes the arm to swing towards the actuator 42 and away from the riser 2. This position is illustrated in FIG. 4.

FIG. 5 illustrates details of the gripper portion 30 of the second gripper arm 16 in its clamped position from the reverse side to that shown in FIG. 3.

The vehicle 10 is adapted to rotate around the axis of the riser 2, preferably so as to be able to rotate completely around the riser 2. This permits the vehicle 10 to rotate to the optimal angle to pass a protuberance 6. For example, the riser 2 may have multiple protuberances extending in different directions from the riser 2, thus meaning that the vehicle 10 must be re-orientated part way along the riser 2. In some embodiment, the vehicle 10 may rotate to position tools or operational modules in the correct position.

To provide this rotation function, each of the clamps 32a, 32b, 34a, 34b comprises a housing and a friction pad. The friction pad is movable with respect to the housing. Thus, by relative movement of the friction pad and the housing, it is possible to rotate the vehicle 10 about the riser 2, when the first gripper arm 14 is disengaged from the riser 2 (or where the first gripper arm 14 also rotates its friction pads correspondingly).

Each friction pad and housing only needs a relatively small degree of movement because the rotation can be applied in a step-wise manner. For example, after rotation of the vehicle 10, the first gripper arm 14 can be engaged and the second gripper arm 16 released. The friction pads can be reset to their neutral position. The second gripper arm 16 can be re-engaged (and the second gripper arm 14 released if necessary) and the rotation process repeated.

The rotation process can be repeated until a desired degree of rotation is achieved. This allows the vehicle 10 to be completely rotated around the riser. Thus, the vehicle 10 can be aligned to pass a protuberance 8 on the riser 2 or, for example, to pass through a narrow opening on one side of the riser 2.

A method of using the vehicle 10 may comprise translating the vehicle 10 to a target axial location along the riser 2 and rotating the vehicle 2 around an axis of the riser 2 to achieve a desired degree of rotation. After achieving the desired rotation, the method may further comprise translating the vehicle 10 past a protuberance 6 on the riser 6. Alternatively, or additionally, the method may comprise, after achieving the desired rotation, performing an operation on the riser 2 using the vehicle 10.

FIGS. 6 and 7 show details of a guide 20 for use with the vehicle 10. The guide 20 comprises two rollers 44 shaped to engage the riser 2. Each roller 44 is supported by a guide arm 46 that is pivotally connected to a yoke 47 mounted to the support structure 12. The guide arm 46 in the illustrated arrangement is biased towards a neutral position where the guide arms 46 extend substantially perpendicular to the riser 2 and hold the rollers in contact with the riser 2. However, in alternative embodiments, the position of the guide arms 46 may be actively controlled by other means, for example using a rotational actuator or the like.

When the guide 20 reaches a protuberance 8 on the riser 2, the rollers 44 are pushed away from the neutral position to allow them to pass over the protuberance. After passing, the rollers 44 are biased back to their neutral position to engage the riser 2 on the other side.

Whilst the guide arm 46 in the illustrated arrangement is biased towards a neutral position, in alternative embodiments, the position of the guide arms 46 may be actively controlled by other means, for example using a rotational actuator or the like.

The guide 20 illustrated in FIGS. 6 and 7 differs from the guides 20a, 20b, 20c shown in FIG. 1. In FIG. 1, the arms of the yokes 47 of the guides 20a, 20b, 20c are instead pivotable about an axis parallel to the axis of the riser 2 to disengage the rollers 44 from the riser 2. In this arrangement, the engagement and disengagement of the guide 10 is actively controlled by a controller of the vehicle 10.

FIGS. 8 to 10 illustrate a repair module 18 to be carried by the vehicle 10. The repair module 18 is a variation of the module described in WO2012/013847 (also published in English as EP2600051A4).

The repair module 18 is a reusable repair module. It may comprise a housing 48 shaped to surround the riser 2, establishing a sealed chamber between the housing 48 and the riser 2. Once the sealed chamber has been established, the repair module 18 may be capable of draining water from the sealed chamber and may be performing a repair on the riser 2 using a self-contained riser repair apparatus, as described in WO2012/013847. It is envisaged that an umbilical may connect the repair module 18 to the surface to supply a source of fluid for expelling water from the sealed chamber. The fluid may be air or other gas, pure water, a cleaning fluid or other agent. In some arrangements the vehicle 10 or repair module 18 may include a local source of pressurised gas or other agent to supply the fluid.

Whilst the housing 48 is described in combination with the repair module 18 in this embodiment, in other embodiments the housing 48 may be used in combination with other operational modules, e.g. so as to provide a controlled environment for performing the respective operation on the riser 2.

The housing 48 of the repair module 18 comprises two housing segments 48a, 48b. When engaged with one another around a riser 2, the housing segments 48a, 48b form the sealed chamber. The housing segments 48a, 48b are similar in nature to those described in WO2012/013847. However, instead of being separated by linear movement, the housing segments 48a, 48b are separated by a rotational movement about a pivot axis, as illustrated in FIGS. 9 and 10.

Also contrary to WO2012/013847, the repair module 18 illustrated in FIGS. 8 to 10 does not include collar segments for causing the repair module 18 to translate along the riser 2. Instead, the repair module 18 is carried by the support structure 12 via a frame 50, although alternative structure types may be used in place of the frame 50. The frame 50 is capable of carrying the weight of the repair module 18 both subsea, in the splash zone and above the sea surface. The frame 50 provides pivots about which the housing segments 48a, 48b rotate to engage or disengage the riser 2. The frame 50 is shaped so that the housing segments 48a, 48b will close around the riser 2 when mounted to the support structure 12 of the vehicle 10, which is held at a predetermined distance from the riser 2 by the gripper arms 14, 16 and the guides 20.

The movement of each of the housing segments 48a, 48b is controlled by a respective actuator 52a, 52b mounted between the frame 50 and the housing segment 48a, 48b, although alternative actuator types may be used. When in their separated position, the housing segments 48a, 48b are capable of passing a protuberance 8 on the riser 6.

To seal against one another, at least one of the housing segments 48a, 48b includes a seal along its free edges. Since the housing segments 48a, 48b are manufactured and maintained to a high precision, a relatively simple seal can be used for sealing between the two housing segments 48a, 48b. However, sealing against the riser 2 itself is more difficult as the riser 2 is exposed to weathering and will often be heavily corroded or worn. Indeed, since part of the riser 2 requires repair, it is likely that the adjacent portion of the riser 2 where the housing 48 must seal will also be damaged.

FIGS. 11 and 12 illustrate a sealing arrangement 56 for sealing the housing 48 against the riser 2. The sealing arrangement 56 is formed in two parts, one provided on each of the respective housing segments 48a, 48b, which are brought together when the housing 48 is sealed against the riser 2.

The sealing arrangement 56 comprises a seal stack including at least three sealing elements 58. The seal elements 58 are shaped to surround the riser 2 when the housing is closed, and will usually each be approximately semi-annular so as to form an approximately annular seal. The sealing elements 58 are formed from an elastomeric material such that, when pressure is applied to the stack in an axial direction, the sealing elements 58 will expand in a radial direction causing them to seal against the riser 2.

Between each of the sealing elements 58 is provided a spacer 60, in this case in the form of a compression ring 60. The functionality of the spacer 60 is twofold. Each spacer 60 provides even axial compression and is also furnished with channels to allow for draining water or balancing of pressure, as will be discussed below. The spacers 60 are formed from a stiffer material, such as steel, so as to distribute a compressive force applied to the seal stack.

The sealing arrangement further comprises a compression assembly for applying an axial compression to the seal stack. The compression assembly comprises a rigid frame 62 for supporting one axial end of the seal stack and means for compressing the seal stack against the rigid frame 62. In the illustrated embodiment, the means comprises a compression ring 64, a plurality of lever arms 66 mounted to the frame for applying a compressive force to the compression ring 64, and a plurality of actuators 68 (shown in FIG. 8) for actuating the lever arms 66, although alternative actuator types may be used. In further alternative arrangements, a similar compressive force can be applied using a threaded device (e.g. a nut) that is screwed down, pushing on the compression ring 64.

Whilst the compression of the sealing members 58 may be sufficient to seal against the riser 2, in many cases the surface to the riser will be too uneven for the seals alone.

FIG. 12 illustrates aspects of the sealing arrangement 54 which provide enhanced sealing in the case of a riser 2 having a poor surface for sealing.

Between the innermost sealing member 58a and the intermediate sealing member 58b, a pressurised gas barrier is formed. The pressurised gas barrier should be at a pressure higher than ambient sea pressure, such that a positive pressure differential is created across the intermediate sealing member 58a in the outward direction. Thus, even if an imperfect seal is formed between the riser 2 and the seal assembly 54, the water cannot enter the sealed chamber.

The pressurised gas barrier is formed by injecting pressurised gas, ideally the same gas as is used inside the sealed chamber the repair module 18, into the space between the two sealing members 58a, 58b via a compressed gas passageway 64 formed through the frame 62. The barrier gas pressure shall be above external pressure. For example, at 50 meters below sea level, the ambient water pressure would be 5 bar and so the barrier pressure should be more than 5 bar to provide a margin and “positive drag” to push out any leaking water. In some arrangements, the gas pressure may be controlled based on the ambient pressure. In others, a constant pressure may be used that is above a maximum expected ambient pressure. It will be appreciated that the frame 62 must be otherwise airtight. One or more gas passageways may also be formed in the respective compression ring 60a.

The space between the intermediate sealing member 58b and the outermost sealing member 58c is connected to a sump (not shown) via a drain line 66. Any water passing the outermost sealing member 58c is thus drained from the seal assembly to minimise a pressure applied to subsequent seal members. As above, one or more drain passageways may also be formed in the respective compression ring 60b.

The water is preferably drained by gravity. The sump may be a simple container, or may alternatively include a pump for draining the sump.

Where more than three sealing members 58 are present, a drain line 66 may be connected to the region between each of the seal members 58.

The sealing assembly 54 has a modular arrangement such that the sealing elements 58 can be easily replaced to conform to a particular riser. For example, different risers may have different shapes or diameters, or may require different materials to ensure a seal. The sealing elements 58 and compression rings 60 may thus be provided as a cartridge that can be released from the respective halves of the sealing assembly 54 when the housing 48 is in the open position, and a new sealing element cartridge inserted in its place.

Although it may be powered by batteries, the vehicle 10 is preferably powered by means of an umbilical. When the vehicle 10 is performing repairs, according to a preferred embodiment by means of the repair module 18 enabling dry in-situ repairs, direct link to the atmosphere via a tube integrated to the umbilical or installed beside is preferred. Such an arrangement allows emptying of sea water from the housing 48 and/or supply of drying and/or cleaning and/or repair fluids. It further enables gravity drainage of a sump of the seal arrangement 56 which is part of the preferred housing 48 described herein. Incorporated or associated with the umbilical may be other tubes connecting the vehicle 10 topside, which may provide fluid chemicals for repair or other operations, or compressed fluids for one or more of cleaning, drying, repair or the like.

FIG. 16 shows the vehicle 10 operating as a carrier vehicle 10 carrying an ROV (remotely operated vehicle) module. This module allows the vehicle 10 to operate as a mobile launchpad for a remote vehicle 82. Such a configuration allows the vehicle 10 to perform operations at a distance further away from the riser 2 than would otherwise be possible, e.g. when using the manipulator module 69. For example, the ROV 82 may be able to perform inspection and maintenance on a wellhead or on subsea structures in the vicinity of the riser 2. In some embodiments, the ROV 82 may be able to travel quite far from the riser 2 to perform such operations.

The ROV module comprises a connector for the ROV 82, such as a mounting attachment or docking station carried by the support structure 12 of the vehicle 10, and an ROV 82 capable of being carried by the mounting attachment.

The connector or the ROV 82 may comprise one or more locking elements to avoid uncontrolled release of the ROV 82. The connector 82 may comprise guide elements for guiding the ROV 82 into a correct position to be carried by the carrier vehicle 10, for example so as to engage the locking element(s).

The connector for the ROV 82 may include a wet-mate subsea connector for supply of electrical power to the ROV 82 when docked with the carrier vehicle 10 and/or for exchange of data between the ROV 82 and the carrier vehicle 10. The connector for the ROV 82 may use electrical communication (e.g. via copper contacts/cables) or optical communication (e.g. via optical fiber contacts/cables).

Where the ROV 82 is a tethered ROV, it may be connected via an umbilical to the vehicle 10, which avoids the need for a dedicated umbilical back to the surface (although such a configuration is also possible). In alternative embodiments, the ROV 82 may draw power to recharge an onboard battery when engaged with the carrier vehicle 10, and thus a non-tethered ROV 82 may be used.

The ROV 82 may be fully controlled from the platform, a ship or by distance from an onshore operation centre, either wirelessly or via one or more umbilicals. In some arrangements, the ROV 82 may be autonomous, or have a combination of autonomous and controlled functions. The ROV 82 may include a local power source, such as a battery. Thus, where wireless communication or only autonomous functionally is used the ROV 82 can be completely untethered. Where wireless communication is used, this is preferably a low band connection.

The ROV 82 preferably comprises one or more electrical thrusters to permit movement of the ROV 82. Each electrical thruster may comprise a propeller driven by an electric motor to generate a thrust to move the ROV 82.

The ROV 82 may be equipped with inspection tools, such as cameras, ultrasonic sensors, transducers, sonar and the like. Such sensors may be used to guide the ROV 82 and/or to perform inspection of the riser 2, the carrier vehicle 10 or other features in the vicinity of the ROV 82. Alternatively, or additionally, positioning elements such as sensors, reflectors, locator elements and the like may be positioned within the area where the ROV 82 is to perform work, in order to allow accurate positioning. The sensor elements may communicate with the ROV 82 directly or may communicate with a controller of the ROV 82 to provide positioning feedback.

Although not shown, the ROV 82 may be equipped with manipulators, for example similar to those used in the manipulator module 69. The ROV 82 may also be equipped with other tools, such as cleaning tools, torque tools, and the like.

By providing an ROV module, the vehicle 10 is able to inspect and perform operations on a complete subsea platform structure associated with the riser 2, including those areas of the structure which are not accessible for the vehicle 10 itself.

The use of an ROV module on the vehicle 10 is also advantageous compared to conventional ROV solutions because it provides an improved means of launching an ROV. An ROV 82 cannot operate in the splash zone in the immediate vicinity of a platform, for example. Thus, an ROV 82 will either be launched and returned from/to a separate vessel, which will typically be stationed in port and requested as required, or it will be launched by a dedicated launch and recovery system (LARS) installed on the platform. However, these are large structures and are not common on smaller platforms. Thus, the modular carrier vehicle 10 can be used to launch an ROV 82 on short notice and can be easily stored on the platform.

Also, the ROV 82 often needs to operate in a confined space with risers, umbilicals, jacket legs, etc. Wind and currents in shallower water can make navigation of the ROV 82 through these obstacles difficult. The vehicle 10 offers safe and controlled transport of the ROV 82 through the splash-zone, below which it can then be released to perform a specific operation.

When implementing an ROV 82 on the carrier vehicle 10, the ROV 82 may be connected to the carrier vehicle 10 by means of a docking station.

It will be appreciated that any of the operational modules discussed above in respect of the carrier vehicle 10 may also be mounted to the ROV 82. Thus, the ROV 82 permits operations to be carried out on objects that are difficult for the carrier vehicle 10 to access directly. For example, the ROV 82 could be used to perform inspection, repair or maintenance operations on chains, etc.

In some embodiments, the carrier vehicle 10 may be used to perform one operation whilst the ROV 82 performs a second operation.

In one example, the carrier vehicle 10 may inspect the riser 2 whilst the ROV 82 performs another operation, for example inspection of other structures such as other risers or part of a jacket structure of the platform.

In another example, the ROV 82 may clean the riser 2 before the carrier vehicle 10 inspects the riser 2 after cleaning, i.e. with the carrier vehicle 10 following the ROV 82. In other operations, the operations may be reversed with the ROV 82 performing inspection and the carrier vehicle 10 performing cleaning.

In other embodiments, the carrier vehicle 10 may be immobilised for longer periods after translation along the riser 2 upon reaching the target depth or position. This would present a near-static base for activity of the ROV 82, which may be of interest when planning for long jobs, or repeated jobs at the same location. As an example, a battery-powered ROV 82 could reconnect to its docking station and reload upon low level battery, or between jobs. The ROV 82 could then also download and transmit all data acquired during the job and stored on a buffer data storage.

The ROV 82 may be used to provide propulsion for the carrier vehicle 10 whilst the ROV 82 is engaged with the carrier vehicle 10. For example, the carrier vehicle 10 may disengage from the riser 2 and the ROV 82 may be used to transport the carrier vehicle 10 to another location, such as another riser or a part of the jacket structure. In another example, the ROV 82 may be used to control and position the carrier vehicle 10 on the riser 2.

The ROV 82 may be used to assist the other functions of the carrier vehicle 10. For example, the ROV 82 may be used to install, remove or interchange the operational modules of the carrier vehicle 10, e.g. the carrier vehicle 10 may carry alternative, interchangeable operation modules.

The ROV 82 may be configured to perform cleaning, maintenance or repair operations on the carrier vehicle 10, and/or the carrier vehicle 10 may be configured to perform cleaning or repair operations on the ROV 82.

A particular application of this local docking station concept would be to install a static docking station at the point of interest of the subsea structure, as a support and possibly storage of the ROV 82.

The carrier vehicle 10 may also perform installation operations, such as deploying a new cable linking a platform to a subsea unit. A module on the vehicle 10 may carry a roll of cable connected to the platform, and translate down the riser 2 to the seafloor, where for example a ROV 82—possibly also carried by a module of the carrier vehicle 10—will finalise connection to the subsea unit. In an alternative arrangement, the roll of cable may instead be mounted on the platform and an end of the cable may be carried by the vehicle 10, with the cable being unrolled at the vehicle 10 translates down the riser 2.

As mentioned previously, the vehicle 10 is configured to be modular so as to carry a different payload for different operations. For example, the vehicle 10 may comprise one or more universal connections to which different modules may be connected, the universal connections being configured to support the weight of the module as well as supplying power and control. In alternative arrangements, the modules may be connected in other manners, such as using separate connections for structural connections, control connections and power connections.

The vehicle 10 can carry one or several modules at a time.

When carrying several modules, the vehicle 10 can operate with one module active at a time, or several modules active simultaneously. For example, one can imagine having cleaning performed under camera inspection.

The vehicle 10 may carry several modules, although all of them are not necessarily connected and powered. For example, one may consider one active module connection, to which the module to be operated can be selected on the vehicle—the vehicle 10 functioning thus also as a kind of “tool rack”- and connected, topside or underwater using for example to an automatically tool swap subsystem (not shown) installed on the vehicle 10.

In one mode of operation, the repair module 18 may be supplemented by or replaced instead by one or more robotic arm modules 69, such as illustrated in FIG. 13.

The robotic arm module 69 comprises a mount 70 for attachment to the support structure 12 of the vehicle 10. The robotic arm module 69 further comprises an articulated arm 72 with a manipulator 74 at the end. Such arms modules 68 are commonly used on remotely operated underwater vehicles (ROVs) used in the prior art for maintenance of risers 2.

In one embodiment, the manipulator 74 may be configured to hold (or replaced with) a cleaning tool 76, 76′, as illustrated in FIGS. 14 and 15. The cleaning tool illustrated in FIG. 14 comprises a rotating brush. The illustrated cleaning tool in FIG. 15 comprises a plurality of outwardly extending elastomeric cleaning elements that are rotatable by a rotor so as to repeatedly impact against a surface of the riser 2.

The manipulator 74 may further be modified to include water nozzles 78, 80 to provide cleaning, in addition to the cleaning tool 76, as shown in FIG. 15. The water nozzles 78, 80 allow for improved cleaning of parts that are too small or delicate to be cleaned using the cleaning tool 74 and/or spraying of the riser 2 above sea level to lubricate the cleaning action of the cleaning tool 76.

In a preferred mode of operation, the vehicle 10 can be used to carry out a routine maintenance and inspection process on a riser 2.

During a first process, the vehicle 10 is loaded with the cleaning module (such as the robotic arm module 69 including the cleaning tool 76) and passes along the length of the riser 2 removing accumulated matter. The vehicle 10 then returns to the surface where the cleaning module is detached.

During a second process, the vehicle 10 is loaded with an inspection module. Whilst such a module is not described in detail herein, suitable inspection devices are well-known in the technical field. The inspection module should be capable of performing non-destructive testing (NDT) of the riser 2 to determine where repairs are required. The vehicle 10 then returns to the surface where the inspection module is detached.

During a third process, assuming such a repair site is identified, the vehicle 10 is loaded with the repair module 18. The vehicle translates along the riser 2 until it reaches the repair site where the two segments of the housing 48 are sealed around the riser 2 and a repair is carried out. Once the repair is complete, the vehicle 10 will return to the surface where the repair module is detached.

During the repair, should the repair module 18 detect that insufficient sealing has been achieved by one or both of the sealing arrangements 54 at its ends, then the vehicle 18 will first attempt to move along the riser 2 in either direction to achieve an improved seal. If, after a predetermined number of attempts, insufficient sealing can be achieved to ensure a dry environment, one may decide to return the vehicle 10 to the surface. One or more further cleaning processes, such as described above, may then be carried out to attempt to obtain a good seal, or an alternate method of repair or replacement may be used. For example, the sealing elements 58 can be replaced with elements having improved sealing properties for a rough surface, such as softer and thicker rubber. If no satisfactory sealing can be achieved, a “wet” repair method can be selected.

The carrier vehicle 10 may be configured to engage with a guest vehicle, for example an unmanned underwater vehicle (UUV), such as a remotely operated underwater vehicle (ROUV) or an autonomous underwater vehicle (AUV). The guest vehicle may be a vehicle separate from the ROV 82. The carrier vehicle 10 may, for example, include connections to permit subsea supply or resupply of the carrier vehicle 10 by the guest vehicle or of the guest vehicle by the carrier vehicle 10. The supply or resupply may be of power, fuel, operational materials or the like. The connections may be provided as part of one of the modules or elsewhere on the carrier vehicle 10.

The connector for the guest vehicle may comprise one or more locking elements to avoid uncontrolled release of the guest vehicle when engaged with the carrier vehicle 10. The connector may comprise guide elements for guiding the guest vehicle into a correct position to be engage the carrier vehicle, for example so as to engage the locking element(s).

The connector for the guest vehicle may include a wet-mate subsea connector for supply of electrical power with the guest vehicle when docked with the carrier vehicle 10 and/or for exchange of data between the guest vehicle and the carrier vehicle 10. The connector for the guest vehicle may use electrical communication (e.g. via copper contacts/cables) or optical communication (e.g. via optical fiber contacts/cables).

Whilst the embodiments described above describe the vehicle 10 in use on a riser 2, it will be appreciated that the vehicle 10 may be used to carry a payload along any elongate structure having a substantially uniform cross-section. Other subsea examples include, for example, pipelines or platform legs. In one example embodiment, the vehicle 10 could be used on an underwater elongated body associated with a wind turbine tower. In further embodiments, the vehicle 10 may be used on elongate bodies above water. In yet further examples, the device may be used topside also, for example to climb pipes or scaffolding for other maintenance purposes.

Furthermore, whilst the described riser 2 is illustrated in a vertical orientation, it will be appreciated that the vehicle 10 may be used in combination with elongate structures having any orientation. For example, the vehicle 10 may be used on horizontal pipelines.

Whilst the support structure 12 illustrated in the present embodiment comprises a single, elongate structural member, it is still capable of following a riser 2 having a small degree of curvature, as might be expected for a riser 2. For more complex structures, however, the support structure 12 may comprise an articulated member, having two or more hinged sections. Optionally, each hinged section may comprise a pair of gripper arms operating in a similar manner to the first and second gripper arms 14, 16 described above. Indeed, in some embodiment, multiple pairs of gripper arms 14, 16 may be employed even for a support structure 12 comprising only a single rigid body.

In a further embodiment, whilst the first gripper arm 14 is illustrated as being a fixed, it may alternatively be embodied as a sliding gripper arm, similar to the second gripper arm 16.

In further embodiments, the system may be used for the purpose of subsea debris survey and/or removal. For example, the carrier vehicle 10 and/or the ROV 82 may use an inspection module to inspect an area surrounding the riser 2. The carrier vehicle 10 or the ROV 82 may additionally or alternatively use a manipulator module, such as the robotic arm 69, to collect articles on or around the riser 2. The carrier vehicle 10 may comprise a container for storing collected matter. Thus, the system may be used to bring collected material to a platform or other collection location.

In a further embodiment, the carrier vehicle 10 may be used to provide a local communication hub between one or more subsea units and a unit on the surface. For example, the carrier vehicle 10 may be equipped with a communication module for communication with subsea units such as the ROV 82 or other vehicles in the vicinity of the carrier vehicle 10. The communication unit may use wireless communication or wired communication. The carrier vehicle 10 may comprise a wired line connecting to the unit on the surface. For example, the wired line may run alongside an umbilical such as those discussed above for supplying power or fluids for use on the carrier vehicle 10. Alternatively, wireless communication may be used as larger antennas and amplifiers can be mounted to the carrier vehicle 10 than on the ROV 82.

In a further embodiment, the vehicle 10 can comprise a memory unit for storing data collected subsea. For example, the data may comprise underwater surveillance data, which could for example be relayed by a subsea vehicle such as the ROV 82 or could be collected by an inspection module mounted

In yet further embodiments, the carrier vehicle 10 or the ROV 82 may be mounted with an offensive module and/or defensive module. The carrier vehicle 10 may thus be configured to engage in warfare, or to enhance the security of a platform installation associated with the riser. It may in such case be equipped with various underwater detection sensors.

1. A carrier vehicle for carrying a secondary vehicle along an elongate body, the carrier vehicle comprising:
a support structure configured to carry the secondary vehicle; and
a translation mechanism connected to the support structure for causing the carrier vehicle to translate along the elongate body,
wherein the secondary vehicle is capable of movement independently of the carrier vehicle.

2. The carrier vehicle according to claim 1, wherein the carrier vehicle is a crawler-type carrier vehicle.

3. The carrier vehicle according to claim 1, wherein the carrier vehicle is configured to pass a protuberance on the elongate body.

4. The carrier vehicle according to claim 1, wherein the elongate body is a tubular body.

5. The carrier vehicle according to claim 1, wherein the translation mechanism comprises at least two translation members, each being configured to be disengageable from the elongate body to pass a protuberance.

6. The carrier vehicle according to claim 5, wherein the translation mechanism is configured such that, when the vehicle translates, at least one translation member is engaged with the elongate body at all times.

7. The carrier vehicle according to claim 6, wherein the vehicle is configured such that the at least one translation member remains engaged with the elongate body when not receiving power.

8. The carrier vehicle according to claim 5, wherein each translation member further comprises a gripper configured to grip the elongate body.

9. The carrier vehicle according to claim 1, wherein the carrier vehicle is configured to carry at least one operational module.

10. The carrier vehicle according to claim 9, wherein the at least one operational module is configured to perform an operation on the elongate body of at least one of a group consisting of an inspection operation, a maintenance operation, a cleaning operation, and a repair operation.

11. (canceled)

12. The assembly comprising a carrier vehicle according to claim 1 and a secondary vehicle carried by the carrier vehicle.

13. The assembly according to claim 12, wherein the secondary vehicle is arranged to operate as at least one of a group consisting of an unmanned vehicle, a remotely operated vehicle, and an autonomous vehicle.

14. The assembly according to claim 12, wherein the secondary vehicle is equipped with at least one of a group consisting of a sensor, a manipulator, a cleaning tool, and a maintenance tool.

15. The assembly according to claim 12, wherein the secondary vehicle comprises a battery and is configured to recharge the battery when connected to the carrier vehicle.

16. A method of performing an operation on a remote structure in the vicinity of an elongate body, the method comprising:
carrying a secondary vehicle to a launch location along the elongate body using a carrier vehicle that translates along the elongate body;
releasing the secondary vehicle from the carrier vehicle, such that the secondary vehicle is capable of movement independently of the carrier vehicle; and
performing the operation on the remote structure using the secondary vehicle.

17. The method according to claim 16, further comprising, after performing the operation:
mounting the secondary vehicle to the carrier vehicle; and
carrying the secondary vehicle to another location along the elongate body using the carrier vehicle.

18. The method according to claim 16, wherein the elongate body is a subsea tubular structure.

19. The method according to claim 18, wherein the secondary vehicle is a subsea vehicle.

20. The method according to claim 19, wherein the secondary vehicle is carried from a topside location to a subsea launch location.

21. The method according to claim 16, wherein the operation comprises at least one of a group consisting of an inspection operation, a cleaning operation, a maintenance operation, and a repair operation.

22. The carrier vehicle according to claim 4, wherein the tubular body is a riser.

23. The method according to claim 18, wherein the subsea tubular structure is a riser.

24. The method according to claim 19, wherein the subsea vehicle is one of a remotely operated underwater vehicle or an autonomous underwater vehicle.
